(19) United States
(12) Patent Application Publication
(10) Pub. No.: US 2025/0137629 A1
(43) Pub. Date: May 1, 2025

(54) LUMINAIRE SUPPORTING MULTIPLE CONNECTION STATES

(71) Applicant: Shinegrow ( Xiamen ) Lighting Technology Co., LTD., Xiamen (CN)

(72) Inventors: FUXING LU, Xiamen (CN); Liangliang Cao, Xiamen (CN); Jinsheng Li, Xiamen (CN)

(73) Assignee: Shinegrow ( Xiamen ) Lighting Technology Co., LTD., Xiamen (CN)

(21) Appl. No.: 18/902,808

(22) Filed: Sep. 30, 2024

(30) Foreign Application Priority Data
Oct. 30, 2023 (CN) 202322921048.3

(51) Int. Cl. F21V 23/00; A01G 9/24; F21V 15/01; F21V 15/015; F21V 29/70; F21V 29/89; F21V 31/00; F21Y 115/10

(52) U.S. Cl. CPC F21V 23/002; A01G 9/249; F21V 15/012; F21V 15/015; F21V 29/70; F21V 29/89; F21V 31/005; F21Y 2115/10

(57) ABSTRACT

A luminaire supporting multiple connection states includes at least one light-emitting module and two end caps. The light-emitting module has a driver disposed therein. The end caps are disposed at the two ends of the light-emitting module respectively. One of the end caps includes a plurality of connection holes, and a power cable penetrates through each of the connection holes to be electrically connected to the driver. The light-emitting module achieves a connection state by electrically connecting one of the power cables thereof to the power cable of another light-emitting module adjacent thereto via one of the connection holes. The luminaire can achieve many advantages, such as flexible wiring, convenient installation, diverse lighting functions, etc., in order to meet the requirements of various growth stages of plants.

### BACKGROUND OF THE INVENTION

### 1. Field of the Invention

The present invention relates to a luminaire, in particular to a luminaire supporting multiple connection states.

### 2. Description of the Prior Art

Currently, most of currently available plant lights adopt semiconductor circuit in order to promote the growth of flowers, vegetables, and other plants. Research indicates that the backside of leaves and roots are also conducive to photosynthesis. However, indoor plants, such as flowers, tend to grow taller and denser over time, resulting in some areas receiving insufficient light, thus affecting their growth. Currently available light sources mainly use LED lights to illuminate plants from top to bottom to promote their growth. However, currently available LED lights typically only emit light in one direction, which is not conducive to the full photosynthesis of plants. To address this issue, plant lights need to adopt multi-angle illumination to maximize the utilization of photosynthesis in plants. However, most of currently available plant lights only supports one connection state, which limits the diversification of plant light layouts for achieving multi-angle illumination in plant factories or greenhouses.

Therefore, it has become an important issue to provide a lighting device capable of illuminating flowers and other plants in plant factories or greenhouses.

### SUMMARY OF THE INVENTION

One embodiment of the present invention provides a luminaire supporting multiple connection states, which includes at least one light-emitting module and two end caps. The light-emitting module has a driver disposed therein. The end caps are disposed at the two ends of the light-emitting module respectively. One of the end caps includes a plurality of connection holes, and a power cable penetrates through each of the connection holes to be electrically connected to the driver. The light-emitting module achieves a connection state by electrically connecting one of the power cables thereof to the power cable of another light-emitting module adjacent thereto via one of the connection holes.

In one embodiment, the light-emitting module includes a light source board electrically connected to the driver, a section bar configured to dissipate heat and for mounting the light source board, and a light cover disposed on the section bar to cover the light source board.

In one embodiment, the end cap is provided with a perforation, a sealing ring and a silicon plug. A fixing member passes through the perforation to fix the end cap on the section bar. The sealing ring is disposed inside the end cap to seal the space between the end cap and the light cover. The silicone plug is inserted into the perforation to cover the fixing member.

In one embodiment, the end cap has a top surface and a side wall surrounding the top surface. Each of the connection holes is formed on the side wall or the top surface and the side wall.

In one embodiment, the end cap is provided with a buckle.

In one embodiment, the luminaire further includes a fixing base engaged with the buckle.

In one embodiment, the connection state is a T-shaped connection state.

Another embodiment of the present invention provides a luminaire supporting multiple connection states, which includes at least one light-emitting module and two end caps. The light-emitting module has a driver disposed therein. The end caps are disposed at the two ends of the light-emitting module respectively. Each of the end caps includes a plurality of connection holes, and a power cable penetrates through each of the connection holes to be electrically connected to the driver. The light-emitting module achieves a connection state by electrically connecting one of the power cables thereof to the power cable of another light-emitting module adjacent thereto via one of the connection holes.

In one embodiment, the end cap has a top surface and a side wall surrounding the top surface. Each of the connection holes is formed on the side wall or the top surface and the side wall.

In one embodiment, the connection state is one of an I-shaped connection state, a Z-shaped connection state, a cross-shaped connection state, or a U-shaped connection state.

According to the embodiments of the present invention, the end caps are respectively installed at the two ends of the light-emitting module, and each end cap has a top surface and a side wall surrounding the top surface. By utilizing connection holes formed on the side wall or the top surface and side wall, various connection states can be achieved. When the end cap at only one end of the luminaire's light-emitting module forms the connection holes for connecting the power cables, the connection state between luminaires is a T-shaped connection state. When the end caps at both ends of the luminaire's light-emitting module form the connection holes for connecting the power cables, the connection state between luminaires is an I-shaped connection state, a Z-shaped connection state, a cross-shaped connection state, or a U-shaped connection state. By utilizing the end caps of each luminaire to connect multiple luminaires through the power cables, and through various connection states mentioned above, diverse wiring can be achieved according to different angles. This luminaire can achieve many advantages, such as flexible wiring, convenient installation, diverse lighting functions, etc., in order to meet the requirements of various growth stages of plants.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a perspective view of a luminaire in accordance with one embodiment of the present invention.

FIG. 2 is an exploded view of the luminaire in accordance with one embodiment of the present invention.

FIG. 3 is a schematic view illustrating a T-shaped connection state in accordance with one embodiment of the present invention.

FIG. 4 is a schematic view illustrating the plants being illuminated by the luminaires in the T-shaped connection state of FIG. 3 in accordance with one embodiment of the present invention.

FIG. 5 is a schematic view illustrating the installation of the luminaire in accordance with one embodiment of the present invention.

FIG. 6 is a perspective view of a luminaire in accordance with another embodiment of the present invention.

FIG. 7 is an exploded view of the luminaire in accordance with another embodiment of the present invention.

FIG. 8 is a schematic view illustrating a I-shaped connection state and a Z-shaped connection state in accordance with one embodiment of the present invention.

FIG. 9 is a schematic view illustrating the plants being illuminated by the luminaires in the I-shaped connection state and the Z-shaped connection state of FIG. 8 in accordance with another embodiment of the present invention.

FIG. 10 is a schematic view illustrating the luminaires installed at different positions of a greenhouse in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

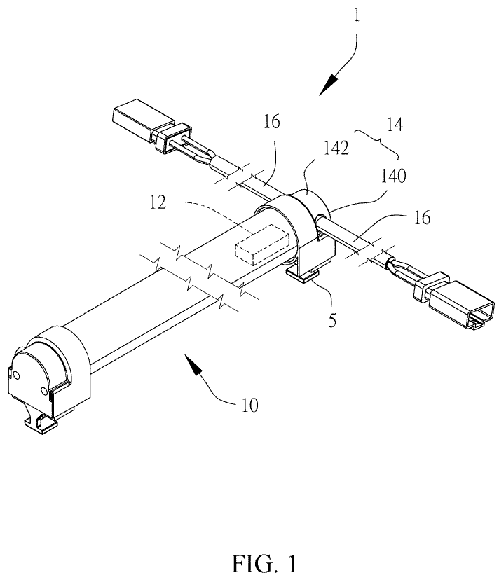

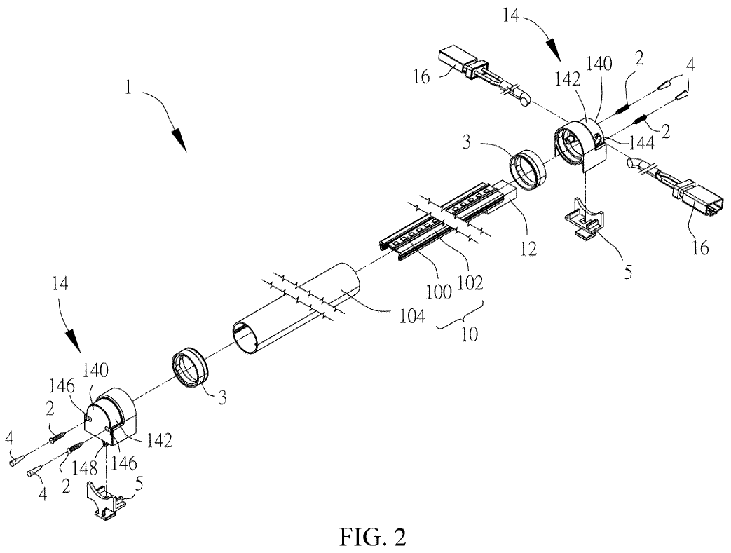

Please refer to FIG. 1 and FIG. 2. FIG. 1 is a perspective view of a luminaire in accordance with one embodiment of the present invention. FIG. 2 is an exploded view of the luminaire in accordance with one embodiment of the present invention. As shown in FIG. 1 and FIG. 2, the embodiment discloses a luminaire 1 supporting multiple connection states. The luminaire 1 includes a light-emitting module 10, a driver 12, two end caps 14, and a plurality of power cables 16. The light-emitting module 10 is provided with a driver 12 disposed therein. The end caps 14 are respectively disposed at the two ends of the light-emitting module 10. Each end cap 14 has a top surface 140 and a side wall 142 surrounding the top surface 140. Multiple connection holes 144 can be formed on the side wall 142 or the top surface 140 and side wall 142 of one of the end caps 14. Each of the power cables 16 passes one of the connection holes 144 to electrically connecting to the driver 12. The light-emitting module 10 can achieve at least one type of connection state by electrically connecting one of the power cables 16 thereof to the power cable 16 of another light-emitting modules 10 adjacent thereto via one of the connection holes 144.

The light-emitting module 10 includes a light source board 100, a section bar 102, and a light cover 104. The light source board 100 is electrically connected to the driver 12, and the section bar 102 is mainly made of extruded aluminum to facilitate the installation of the light source board 100 and achieve thermal conductivity and heat dissipation through the high heat dissipation effect of the section bar 102 itself. The light cover 104 is sleeved over the section bar 102 to cover the light source board 100. When installing the end cap 14, a fixing element 2 (screw) is passed through the perforation 146 of the end cap 14 and locked onto the section bar 102 to fix the end cap 14. Additionally, a sealing ring 3 is disposed between the end cap 14 and the light cover 104. Through the compressive effect caused by the installation of the end cap 14, the sealing ring 3 is tightened and seal the space between the end cap 14 and the light cover 104 to achieve a waterproof sealing effect. Furthermore, after the fixing element 2 is secured, a silicon plug 4 is inserted into and covers the perforation 146 to prevent water or moisture from entering the light cover 104, thus optimizing the waterproof effect.

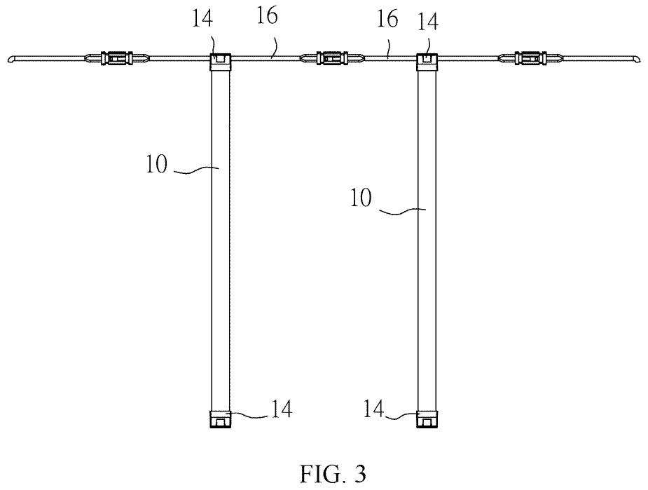

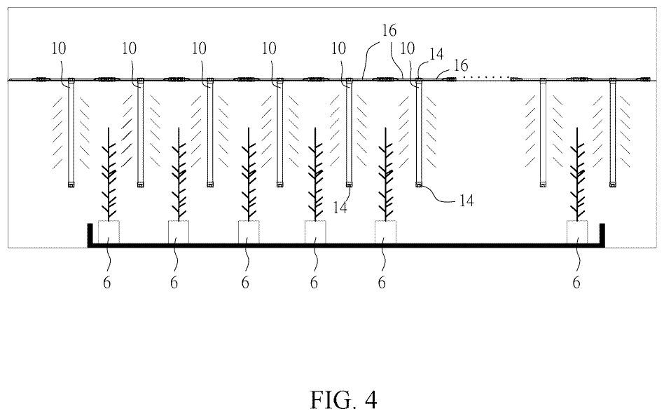

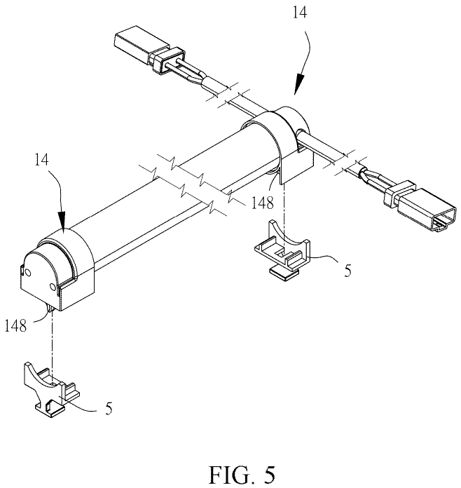

Please refer to FIG. 3, FIG. 4 and FIG. 5. FIG. 3 is a schematic view illustrating a T-shaped connection state in accordance with one embodiment of the present invention. FIG. 4 is a schematic view illustrating the plants being illuminated by the luminaires in the T-shaped connection state of FIG. 3 in accordance with one embodiment of the present invention. FIG. 5 is a schematic view illustrating the installation of the luminaire in accordance with one embodiment of the present invention. In this embodiment, each luminaire 1 is suspended indoors and disposed at one side of the plants in order to illuminate the side of the plants 6 (as shown in FIG. 4). The power cables 16 are disposed at the connection holes 144 of one end cap 14 of each light-emitting module 10. Since each luminaire 1 needs to be connected in series to increase the overall illumination range on the side of the plants, the connection holes 144 are symmetrically disposed on the side wall 142 of the end cap 14. Therefore, the light-emitting modules 10 installed with power cables 16 can achieve a T-shaped connection state as a whole. As shown in FIG. 3 and FIG. 4, the end cap 14 at one end of each light-emitting module 10 is connected to the end caps 14 of the light-emitting modules 10 adjacent thereto through the power cables 16 for electrical connection, while the end cap 14 at the other end of each light-emitting module 10 faces the ground. Thus, the light source board 100 of each light-emitting module 10 faces the side of the plants so as to achieve multi-angle illumination of plants in a plant factory.

In addition to the above structure, as shown in FIG. 5, to enable the luminaire 1 to be directly installed efficiently and conveniently, a buckle 148 is provided at the bottom of the end cap 14. The fixing base 5, which can be engaged with the buckle 148, is used to be installed on the wall or any structure used for installing the luminaire 1. The fixing base 5 can be installed at a proper position according to the required position and distance for installing the luminaire 1, and then the user can directly fix the buckle 148 with the fixing base 5 to complete the installation.

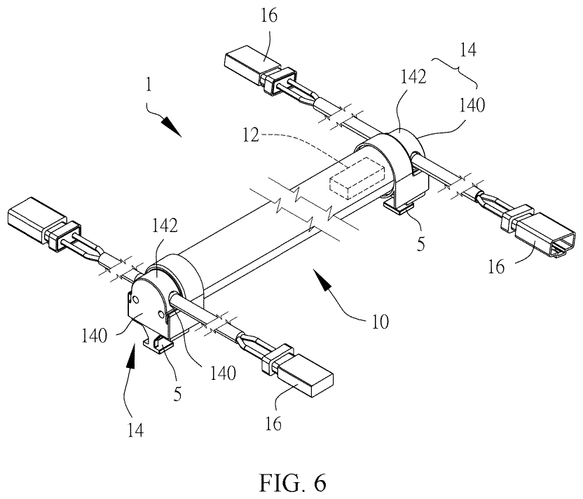

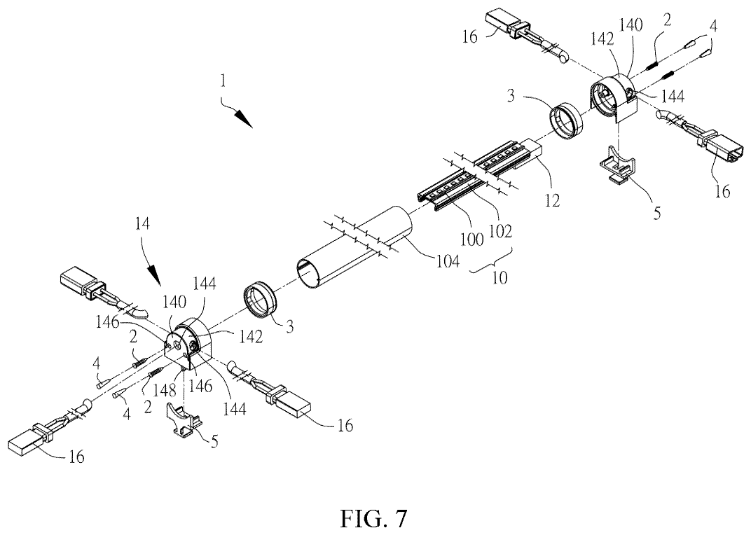

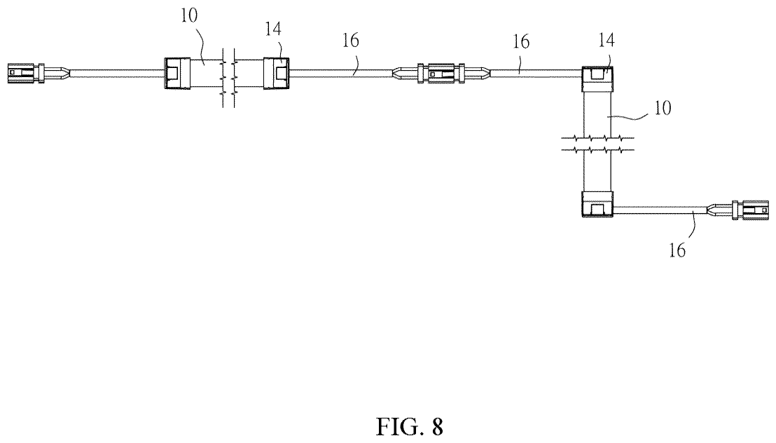

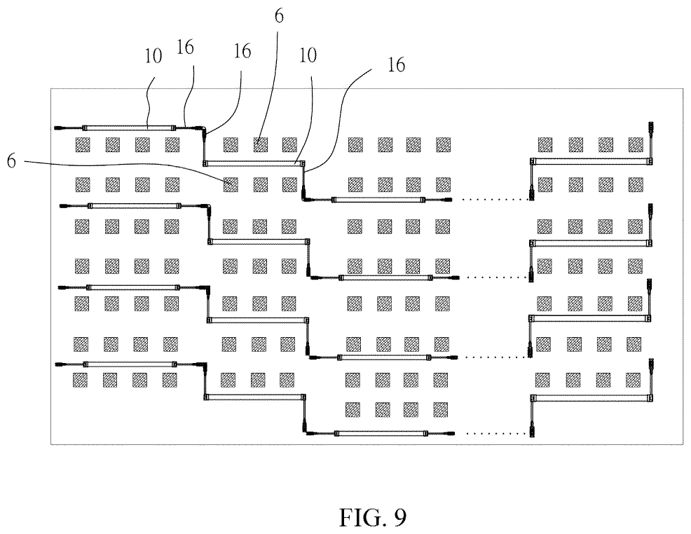

Please refer to FIG. 6, FIG. 7, FIG. 8 and FIG. 9. FIG. 6 is a perspective view of a luminaire in accordance with another embodiment of the present invention. FIG. 7 is an exploded view of the luminaire in accordance with another embodiment of the present invention. FIG. 8 is a schematic view illustrating a I-shaped connection state and a Z-shaped connection state in accordance with one embodiment of the present invention. FIG. 9 is a schematic view illustrating the plants being illuminated by the luminaires in the I-shaped connection state and the Z-shaped connection state of FIG. 8 in accordance with another embodiment of the present invention. In this embodiment, the luminaire 1 differs from the previous embodiment in that the previous embodiment only uses one end of the light-emitting module 10 connected by power cables 16. End caps 14 located at both ends have perforations 146 set on the top surface 140 and a side wall 142 surrounding the top surface 140. The perforations 146 may vary depending on the desired connection state of the luminaire 1. If there is only one perforation 146 on the top surface 140 and two perforations 146 on the side wall 142, several luminaires 1 can be connected with each other to form a cross-shaped connection state. Additionally, if there is only one perforation 146 on the top surface 140, several luminaires 1 cam be connected each other to form the I-shaped connection state. Furthermore, if a single perforation 146 is disposed on the side wall 142 without directional restrictions, several luminaires 1 can be connected with each other to form the Z-shaped connection state or a U-shaped connection state.

As shown in FIG. 9, it can be seen that each luminaire 1 in the embodiment is suspended indoors and disposed above the plants in order to illuminate the at the top of the plants. The power cables 16 are mainly disposed at the connection holes 144 of the end caps 14 at the two ends of the light-emitting module 10. Since these luminaires 1 need to be connected in series to increase the overall illumination range on the top of the plants, the connection holes 144 are disposed on the side wall 142 of the end cap 14. These luminaires 1 can be connected to each other via the power cables 16 to form the Z-shaped connection state or a U-shaped connection state. In addition, one perforation 146 is disposed on the top surface 140 of the end cap 14, and these luminaries 1 can be connected in series to form the I-shaped connection state. In this way, the embodiment can achieve multi-angle illumination. Furthermore, as shown in FIG. 8 and FIG. 9, it can be seen that the arrangement of the luminaires 1 is the I-shaped connection state combined with the Z-shaped connection state, which is applied in a plant factory and arranged between the plants. According to actual illumination requirements and area, various combinations of the I-shaped connection state and the Z-shaped connection state can be freely selected.

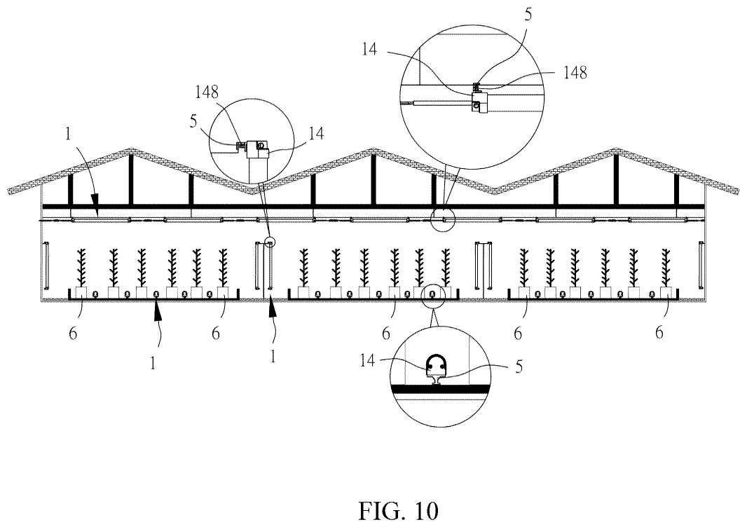

Please refer to FIG. 10, which is a schematic view illustrating the luminaires installed at different positions of a greenhouse in accordance with another embodiment of the present invention. From this embodiment, it can be seen that, similar to the embodiment in FIG. 9, each luminaire 1 can be directly applied above and below indoor plants 6 using the I-shaped connection state combined with the Z-shaped connection state. In order to enable the luminaire 1 to be directly installed efficiently and conveniently (see the enlarged view in FIG. 10), a buckle 148 at the bottom of the end cap 14 is used to be directly engaged with the fixing base 5 installed on the wall or floor. The fixing base 5 can be installed at a proper position according to the required position and distance for installing the luminaire 1, and then the user can directly fix the buckle 148 with the fixing base 5 to complete the installation. In addition to applying each luminaire 1 above and below indoor plants 6 using the I-shaped connection state combined with the Z-shaped connection state, the luminaires 1 shown in FIG. 4 can be also added to illuminate the side of the plants 6. As described above, the luminaire 1 can achieve many advantages, such as flexible wiring, convenient installation, diverse lighting functions, etc., in order to meet the requirements of various growth stages of plants.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A luminaire supporting multiple connection states, comprising:
at least one light-emitting module having a driver disposed therein; and
two end caps disposed at two ends of the light-emitting module respectively, wherein one of the end caps comprises a plurality of connection holes, and a power cable penetrates through each of the connection holes to be electrically connected to the driver, wherein the light-emitting module achieves a connection state by electrically connecting one of the power cables thereof to a power cable of another light-emitting module adjacent thereto via one of the connection holes.

2. The luminaire supporting multiple connection states as claimed in claim 1, wherein the light-emitting module comprises a light source board electrically connected to the driver, a section bar configured to dissipate heat and for mounting the light source board, and a light cover disposed on the section bar to cover the light source board.

3. The luminaire supporting multiple connection states as claimed in claim 2, wherein the end cap is provided with a perforation, a sealing ring and a silicon plug, wherein a fixing member passes through the perforation to fix the end cap on the section bar, wherein the sealing ring is disposed inside the end cap to seal the space between the end cap and the light cover, wherein the silicone plug is inserted into the perforation to cover the fixing member.

4. The luminaire supporting multiple connection states as claimed in claim 1, wherein the end cap has a top surface and a side wall surrounding the top surface, wherein each of the connection holes is formed on the side wall or the top surface and the side wall.

5. The luminaire supporting multiple connection states as claimed in claim 1, wherein the end cap is provided with a buckle.

6. The luminaire supporting multiple connection states as claimed in claim 5, further comprising a fixing base engaged with the buckle.

7. The luminaire supporting multiple connection states as claimed in claim 1, wherein the connection state is a T-shaped connection state.

8. A luminaire supporting multiple connection states, comprising:
at least one light-emitting module having a driver disposed therein; and
two end caps disposed at two ends of the light-emitting module respectively, wherein each of the end caps comprises a plurality of connection holes, and a power cable penetrates through each of the connection holes to be electrically connected to the driver, wherein the light-emitting module achieves a connection state by electrically connecting one of the power cables thereof to a power cable of another light-emitting module adjacent thereto via one of the connection holes.

9. The luminaire supporting multiple connection states as claimed in claim 8, wherein the end cap has a top surface and a side wall surrounding the top surface, wherein each of the connection holes is formed on the side wall or the top surface and the side wall.

10. The luminaire supporting multiple connection states as claimed in claim 8, wherein the connection state is one of an I-shaped connection state, a Z-shaped connection state, a cross-shaped connection state, or a U-shaped connection state.
